(19) United States
(12) Patent Application Publication
(10) Pub. No.: US 2012/0200530 A1
(43) Pub. Date: Aug. 9, 2012

(54) INPUT DEVICE, AND METHOD FOR DETECTING THE CONTACT POSITION OF THE DEVICE

(75) Inventors: Xiaoling Wu, Yongin-si (KR); Bang-Won Lee, Yongin-si (KR); Se-Eun Jang, Yongin-si (KR); Chul-Yong Joung, Yongin-si (KR)

(73) Assignee: ATLAB INC., Yongin-si (KR)

(21) Appl. No.: 13/501,201

(22) PCT Filed: Oct. 14, 2010
(86) PCT No.: PCT/KR2010/007031

§ 371 Date: Apr. 10, 2012

(30) Foreign Application Priority Data
Oct. 28, 2009 (KR) 10-2009-0102983

(51) Int. Cl. G06F 3/041; G06F 3/044

(52) U.S. Cl. 345/174; 345/173

(57) ABSTRACT

Provided are an input device and a touch position detecting method thereof The input device includes a touch panel configured to generate a plurality of different measurement values depending on touch positions and output the plurality of measurement values, a clustering part configured to receive the measurement values, and output clustered measurement values including at least one cluster from the plurality of measurement values using a threshold value, and a center point calculating part configured to receive the clustered measurement values, and calculate coordinates of each cluster using a weighted average to output the coordinates.

### TECHNICAL FIELD

The present invention relates to an input device, and more particularly, to an input device including a touch panel and a touch position detecting method thereof that is capable of more precisely detecting a touch position.

### BACKGROUND ART

Personal computers, mobile transmission devices, and other information processors perform various functions using input devices. Currently, input devices having touch panels are being widely used.

In general, touch panels are installed on surfaces of display devices such as a cathode ray tube (CRT), a liquid crystal display (LCD), a plasma display panel (PDP), an electroluminescence (EL), etc., to detect a touch position. The touch panels may be formed of an indium tin oxide (ITO) film.

Such an input device having a touch panel may be configured so that a user can touch a certain position on a touch panel with an object, for example, a finger, a stylus pen, etc., to display various information on a screen or perform various functions of the input device. However, in order to make the input device compact or perform more various functions in an apparatus having the input device, contact areas of the contact material such as icons may be reduced. Therefore, in this case, the touch position of the contact material should be measured with more precision.

### DISCLOSURE

### Technical Problem

In order to solve the foregoing and/or other problems, it is an aspect of the present invention to provide an input device capable of more precisely detecting a touch position.

It is another aspect of the present invention to provide a touch position detecting method of the input device capable of accomplishing the above aspect.

### Technical Solution

The foregoing and/or other aspects of the present invention may be achieved by providing an input device including: a touch panel configured to generate a plurality of different measurement values depending on touch positions and output the plurality of measurement values; a clustering part configured to receive the measurement values, and output clustered measurement values including at least one cluster from the plurality of measurement values using a threshold value; and a center point calculating part configured to receive the clustered measurement values, and calculate coordinates of each cluster using a weighted average to output the coordinates.

In the input device, the cluster may be constituted by the measurement values larger than the threshold value among the measurement values.

In addition, the clustering part may receive the measurement values to detect the number of relative maximum values of the measurement values, and output the clustered measurement values including the same number of clusters as the number of the relative maximum values from the measurement values.

Further, the touch panel may include a touch pattern part including a plurality of touch patterns; and a measurement part configured to output an input signal to at least one touch pattern among the plurality of touch patterns, and receive an output signal generated through at least one touch pattern among the plurality of touch patterns to calculate the plurality of measurement values.

According to a first exemplary embodiment of the input device of the present invention, the touch pattern part may include a plurality of first touch patterns disposed in a first direction; and a plurality of second touch patterns disposed in a second direction perpendicular to the first direction, each of the plurality of first touch patterns may include a plurality of first touch pads disposed in the second direction; and a plurality of first connecting pads configured to connect the plurality of first touch pads, and each of the plurality of second touch patterns may include a plurality of second touch pads disposed in the first direction; and a plurality of second connecting pads configured to connect the plurality of second touch pads.

According to a first exemplary embodiment of the input device of the present invention, the measurement part may apply a first reference pulse to each of the first touch patterns as the input signal, receive a first delay pulses generated through the first touch patterns as the output signal, and measure delay time differences between the first delay pulses and the first reference pulse to calculate first measurement values; and may apply a second reference pulse to the second touch patterns as the input signal, receive a second delay pulses generated through the second touch patterns as the output signals, measure delay time differences between the second delay pulses and the second reference pulse to calculate second measurement values, and output the first measurement values and the second measurement values as the measurement value.

According to a first exemplary embodiment of the input device of the present invention, the clustering part may output clustered first measurement values including at least one first cluster having a value larger than a first threshold value among the first measurement values and clustered second measurement values including at least one second cluster having a value larger than a second threshold value among the second measurement values as the clustered measurement value.

According to a first exemplary embodiment of the input device of the present invention, the center point calculating part may calculate coordinates in the first direction using a weighted average with respect to each of the first clusters, calculate coordinates in the second direction using a weighted average with respect to each of the second clusters, and combine the coordinates in the first and second directions to calculate and output coordinates of each cluster.

According to a second exemplary embodiment of the input device of the present invention, the touch pattern part may include a plurality of first touch patterns extending in a first direction, connected to the measurement part at one side in the first direction, and disposed in a second direction; and a plurality of second touch patterns extending in the first direction, connected to the measurement part at the other side in the first direction, and disposed in the second direction. Here, each of the first touch patterns may have a contact area that decreases toward the other side in the first direction; and each of the second touch patterns may have a contact area that decreases toward the one side in the first direction.

According to a second exemplary embodiment of the input device of the present invention, the measurement part may apply a first reference pulse to the one side in the first direction with respect to the first touch patterns as the input signal, receive a first delay pulse generated from the one side in the first direction as the output signal, and measure a delay time difference between the first reference pulse and the first delay pulse to calculate a first measurement value; and apply a second reference pulse to the other side in the first direction with respect to the second touch patterns as the input signal, receive a second delay pulse generated from the other side in the first direction as the output signal, measure a delay time difference between the second reference pulse and the second delay pulse to calculate a second measurement value, and output the first measurement values and the second measurement values as the measurement value.

According to a second exemplary embodiment of the input device of the present invention, the clustering part may receive the first measurement values to calculate clustered first measurement values in the first direction using a first threshold value, receive the second measurement values to calculate clustered second measurement values in the first direction using the first threshold value, calculate measurement values in a second direction added by the first and second measurement values with respect to the first and second touch patterns disposed at corresponding positions in the second direction among the first and second measurement values, receive the measurement values in the second direction to calculate clustered measurement values in the second direction using a second threshold value, and output the clustered first measurement values in the first direction, the clustered second measurement values in the first direction, and the clustered measurement values in the second direction as the clustered measurement value.

According to a second exemplary embodiment of the input device of the present invention, the center point calculating part may calculate coordinates in the first direction of the cluster using a weighted average of corresponding values among the clustered first measurement values in the first direction and the clustered second measurement values in the first direction, and calculate coordinates in the second direction of the cluster using a weighted average of the clustered measurement values in the second direction.

According to a third exemplary embodiment of the input device of the present invention, the touch pattern part may include a plurality of first touch patterns disposed in a first direction; and a plurality of second touch patterns disposed in a second direction perpendicular to the first direction, each of the plurality of first touch patterns may include a plurality of first touch pads disposed in the second direction; and a plurality of first connecting pads configured to connect the plurality of first touch pads, and each of the plurality of second touch patterns may include a first bar extending in the first direction; and a plurality of second bars connected to the first bar, extending in the second direction, and disposed at sides in the first direction of the first touch pads.

According to a third exemplary embodiment of the input device of the present invention, the measurement part may apply the input signal to the second touch patterns, receive the output signal generated from the first touch patterns to measure second capacitances between the first touch patterns and the second touch patterns, and output the measured capacitance as the measurement values.

According to a third exemplary embodiment of the input device of the present invention, the clustering part may subtract the measurement values from a reference value, and then output the clustered measurement value including at least one cluster having a larger value than the threshold value among the subtracted resultant values.

According to a third exemplary embodiment of the input device of the present invention, the center point calculating part may calculate coordinates in the first direction using a weighted average of the measurement values in the first direction among the clustered measurement values with respect to the cluster, calculate coordinates in the second direction using a weighted average of the measurement values in the second direction among the clustered measurement values, and combine the coordinates in the first direction and the second direction to calculate and output coordinates of each cluster.

In addition, the input device may further include a pre-processing part configured to receive the measurement values to remove noises and output standardized measurement values, or receive the measurement values to perform a correction operation and output standardized measurement values, and the clustering part may receive the standardized measurement values to output the clustered measurement values.

Another aspect of the present invention may be achieved by providing a touch position detecting method of an input device including a touch panel configured to generate a plurality of measurement values having different value depending on a touch position and output the plurality of measurement values, the method including: a clustering step of receiving the measurement values, and outputting clustered measurement values including at least one cluster from the plurality of measurement values using a threshold value; and a center point calculating step of receiving the clustered measurement values, and calculating and outputting coordinates of each cluster using a weighted average.

In the touch position detection method in accordance with the present invention, the cluster may be constituted by the measurement values larger than the threshold value among the measurement values.

According to the method of the present invention, the clustering step may include receiving the measurement values to detect the number of relative maximum values of the measurement values, and outputting the clustered measurement values including the same number of clusters as the number of the relative maximum values from the measurement values.

According to a first exemplary embodiment of the method, the touch panel may include a plurality of first touch patterns disposed in a first direction, and a plurality of second touch patterns disposed in a second direction perpendicular to the first direction. Here, each of the plurality of first touch patterns may include a plurality of first touch pads disposed in the second direction, and a plurality of first connecting pads configured to connect the plurality of first touch pads; and each of the plurality of second touch patterns may include a plurality of second touch pads disposed in the first direction; and a plurality of second connecting pads configured to connect the plurality of second touch pads. The touch position detecting method may further include a measurement step of applying a reference pulse to the first touch patterns, measuring a delay time difference between a delay pulse generated through the first touch patterns and the reference pulse to calculate first measurement values, applying the reference pulse to the second touch patterns, measuring a delay time difference between a delay pulse generated through the second touch patterns and the reference pulse to calculate second measurement values, and outputting the first measurement values and the second measurement values as the measurement value.

According to a first exemplary embodiment of the method, the clustering step may include outputting clustered first measurement values including at least one first cluster having a value larger than the first threshold value among the first measurement values and clustered second measurement values including at least one second cluster having a value larger than the second threshold value among the second measurement values as the clustered measurement value.

According to a first exemplary embodiment of the method, the center point calculating step may include calculating coordinates in the first direction using a weighted average with respect to the first clusters, calculating coordinates in the second direction using a weighted average with respect to the second clusters, and combining the coordinates in the first and second directions to output coordinates of each cluster.

According to a second exemplary embodiment of the method, the touch panel may include a plurality of first touch patterns extending in a first direction and disposed in a second direction; and a plurality of second touch patterns extending in the first direction and disposed in the second direction. Here, each of the first touch patterns may have a contact area that decreases toward one side in the first direction, and each of the second touch patterns may have a contact area that decreases toward the other side in the first direction. The touch position detecting method may further include a measurement step of applying a reference pulse to the one side in the first direction with respect to the first touch patterns, measuring a delay time difference between the reference pulse and a delay pulse generated from one side in the first direction to calculate a first measurement value, applying a reference pulse to the other side in the first direction with respect to the second touch patterns, measuring a delay time difference between the reference pulse and a delay pulse generated from the other side in the first direction to calculate a second measurement value, and outputting the first measurement values and the second measurement values as the measurement value.

According to a second exemplary embodiment of the method, the clustering step may include receiving the first measurement values to calculate clustered first measurement values in a first direction, receiving the second measurement values to calculate clustered second measurement values in the first direction using the first threshold value, calculating measurement values in a second direction added by the first measurement value and the second measurement value with respect to the first touch pattern and the second touch pattern disposed at corresponding positions in the second direction among the first measurement values and the second measurement values, receiving the measurement value in the second direction to calculate clustered measurement values in the second direction using a second threshold value, and outputting the clustered first measurement values in the first direction, the clustered second measurement values in the first direction, and the clustered measurement values in the second direction as the clustered measurement value.

According to a second exemplary embodiment of the method, the center point calculating step may include calculating coordinates in the first direction of the cluster using a weighted average of corresponding values among the clustered first measurement values in the first direction and the clustered second measurement values in the first direction, and calculating coordinates in the second direction of the cluster using a weighted average of the clustered measurement values in the second direction.

According to a third exemplary embodiment of the method, the touch panel may include a plurality of first touch patterns disposed in a first direction, and a plurality of second touch patterns disposed in a second direction perpendicular to the first direction, each of the plurality of first touch patterns may include a plurality of first touch pads disposed in the second direction, and a plurality of first connecting pads connecting the plurality of first touch pads; and each of the plurality of second touch patterns may include a first bar extending in the first direction; and a plurality of second bars connected to the first bar, extending in the second direction, and disposed at a side in the first direction of each of the first touch pads. The touch position detecting method may include applying the input signal to the second touch patterns, receiving the output signal generated from the first touch patterns to measure capacitances between the first touch patterns and the second touch patterns, and outputting the measured capacitances as the measurement values.

According to a third exemplary embodiment of the method, the clustering step may include subtracting the measurement values from a reference value, and then outputting the clustered measurement value including at least one cluster constituted by values larger than the threshold value among the subtracted resultant values.

According to a third exemplary embodiment of the method, the center point calculating step may include, with respect to the clusters, calculating coordinates in the first direction using a weighted average of the measurement values in the first direction among the clustered measurement values, calculating coordinates in the second direction using a weighted average of the measurement values in the second direction among the clustered measurement values, and combining the coordinates in the first and second directions to calculate and output coordinates of each cluster.

### Advantageous Effects

According to the present invention, it is possible for an input device and a touch position detecting method thereof to precisely detect a touch position even when a small number of touch patterns are provided.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 is a block diagram of an input device in accordance with an exemplary embodiment of the present invention;

FIG. 2 is a block diagram of an embodiment of a touch panel of the input device shown in FIG. 1;

FIG. 3 shows a constitution of an embodiment of a touch pattern part of the touch panel of the input device shown in FIG. 2;

FIG. 4 shows a constitution of another embodiment of a touch pattern part of the touch panel of the input device shown in FIG. 2;

FIG. 5 shows a constitution of still another embodiment of a touch pattern part of the touch panel of the input device shown in FIG. 2;

FIGS. 6 to 8 are views for explaining an operation of a clustering part when the touch pattern part has the constitution of still another embodiment shown in FIG. 5; and

FIG. 9 is a flowchart for explaining a touch position detecting method of an input device in accordance with the present invention.

### MODE FOR INVENTION

Reference will now be made in detail to the embodiments of the present invention, examples of which are illustrated in the accompanying drawings.

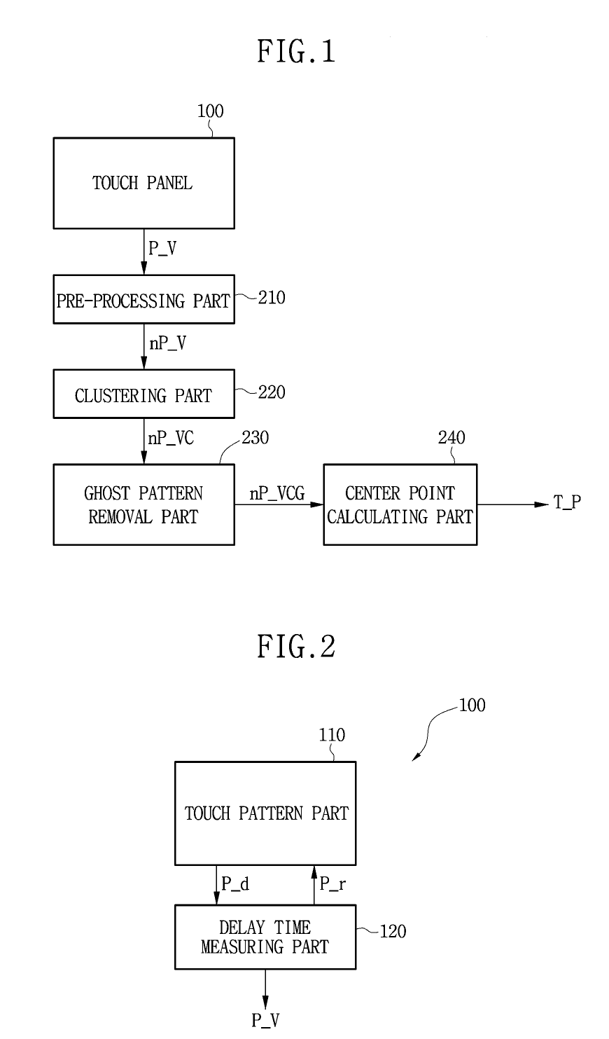

FIG. 1 is a block diagram of an input device in accordance with an exemplary embodiment of the present invention. The input device in accordance with the present invention may include a touch panel 100, a pre-processing part 210, a clustering part 220, a ghost pattern removal part 230, and a center point calculating part 240.

Hereinafter, functions of blocks shown in FIG. 1 will be described in detail.

The touch panel 100 may include a plurality of touch patterns, which output a plurality of different measurement values P_V depending on touch positions of a contact object. The measurement values P_V may be varied delay time depending on the touch positions of the contact object.

The pre-processing part 210 receives the measurement values P_V to remove noises, etc., and performs a correction operation for offsetting effects caused by variation in process or environment to output standardized measurement values nP_V. The pre-processing part 210 can remove noises, etc., using a filter or by setting a threshold value, etc. In addition, the pre-processing part 210 may be configured to perform any one of the noise removal and correction operations.

The clustering part 220 receives the standardized measurement values nP_V to perform a clustering operation to output clustered measurement values nP_V including at least one cluster. The cluster refers to a set of the measurement values P_V (or the standardized measurement values nP_V) corresponding to the touch positions of the contact object. For example, the clustering part 220 can perform the clustering operation using a predetermined threshold value. In this case, the cluster may be constituted by the measurement values larger than the threshold value, among the measurement values P_V (or the standardized measurement values nP_V). That is, the values of the standardized measurement values nP_V smaller than the predetermined threshold value are converted into and output as ‘0’ so that the clustering operation can be performed. In addition, the clustering part 220 may be configured to detect relative maximum values of the standardized measurement values nP_V to determine the number of clusters, and perform the clustering operation depending on the determined number of clusters. When the standardized measurement values nP_V are divided into predetermined sections (or given sets) by a certain method, the relative maximum values refer to local maximum values in the sections (or the sets). In addition, the number of clusters corresponds to the number of touch positions.

The ghost pattern removal part 230 receives the clustered measurement values nP_VC to remove a ghost pattern. For example, the ghost pattern removal part 230 may remove a ghost pattern by receiving the clustered measurement values nP_VC and comparing the measurement values with them, or by using any previously input measurement values when the measurement values are sequentially input.

The center point calculating part 240 calculates and outputs coordinates T_P of each cluster using a weighted average of the ghost pattern-removed measurement values nP_VCG. The coordinates T_P of each cluster refer to a center point of the touch position of the contact object.

Operation of the clustering part 220 and the center point calculating part 240 will be described below in detail. In addition, the input device of the present invention may omit the pre-processing part 210 and/or the ghost pattern removal part 230. That is, the input device of the present invention may include, if necessary, the pre-processing part 210 and/or the ghost pattern removal part 230. When the ghost pattern removal part 230 is not provided, the center point calculating part 240 calculates a center point of the touch position using the clustered measurement values nP_VC.

FIG. 2 is a block diagram of an embodiment of a touch panel 100 of the input device shown in FIG. 1. The touch panel 100 may include a touch pattern part 110 and a measurement part 120.

Functions of the blocks shown in FIG. 2 will be described below.

The touch pattern part 110 may include a plurality of touch patterns, and generate an output signal that varies depending upon the touch position. The output signal may be a delay pulse P_d having a different delay time depending on the touch position. That is, the touch pattern part 110 may include a plurality of touch patterns configured to output delay pulses having different delay times depending on whether or not the contact object is touched or where the contact object is touched. For example, the plurality of touch patterns of the touch pattern part 110 may each receive a reference pulse P_r, and generate a delay pulse P_d having a different delay time depending on whether or not the contact object is touched or where the contact object is touched.

The measurement part 120 outputs an input signal, and receives an output signal generated through the touch pattern part 100 to output a plurality of measurement values P_V. The input signal may be a reference pulse P_r, and the output signal may be a delay pulse P_d. That is, the measurement part 120 can output the reference pulse P_r, and calculate a delay time difference between the delay pulse P_d and the reference pulse P_r generated through the touch pattern part 110 to output a measurement value P_V corresponding to the delay time difference. For example, the measurement part 120 may be configured to sequentially (or simultaneously) apply the reference pulse P_r to the plurality of touch patterns of the touch pattern part 110, sequentially (or simultaneously) receive the delay pulse P_d generated through the plurality of touch patterns of the touch pattern part 110, and calculate the delay time difference of each of the touch patterns to output the measurement value P_V.

While FIG. 2 illustrates an example using a variation in the delay time of the delay pulse depending on the existence of a touch and its position, i.e., outputting the delay time difference between the reference pulse and the delay pulse as a measurement value, the existence of a touch and its position can be detected by various methods. For example, uniform current is sequentially (or simultaneously) applied to the plurality of touch patterns of the touch pattern part 110 to measure a variation in voltage (for example, a time when a voltage arrives at a predetermined threshold voltage, or a magnitude of voltage after a certain time has lapsed), outputting the measurement value. In addition, the measurement value may be output by sequentially (or simultaneously) applying pulse signals having a predetermined pulse width to the plurality of touch patterns of the touch pattern part 110, and determining whether the pulse signal is measured (for example, whether the pulse signal is measured to have a voltage larger than a predetermined threshold voltage).

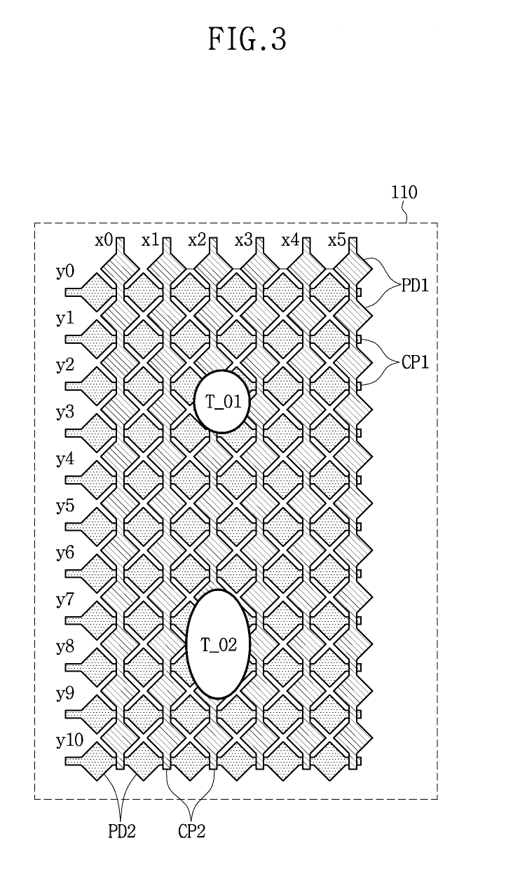

FIG. 3 shows a constitution of a first embodiment of a touch pattern part 110 of the touch panel 100 of the input device shown in FIG. 2. The touch pattern part 110 may include a plurality of first touch patterns x0 to x5 disposed in a first direction, and a plurality of second touch patterns y0 to y10 disposed in a second direction perpendicular to the first direction. In FIG. 3, symbols T_01 and T_02 represent portions touched by the contact object.

The first touch patterns x0 to x5, which are shaded with oblique lines, are insulated from the second touch patterns y0 to y10, which are shaded with dots, at their intersections. For example, the first touch patterns x0 to x5 may be formed on a front surface of an ITO film, and the second touch patterns y0 to y10 may be formed on a rear surface of the ITO film. In addition, the first touch patterns x0 to x5 and the second touch patterns y0 to y10 may be disposed on one surface of the ITO film such that the first touch patterns x0 to x5 are insulated from the second touch patterns y0 to y10 at their intersections. Further, the first touch patterns x0 to x5 and the second touch patterns y0 to y10 may be formed on different ITO films. As described above, the first and second touch patterns may be formed by various methods.

Delay pulses P_d having different delay time are generated through the first touch patterns x0 to x5 depending on the existence of a touch of the contact object or the touch position thereof, and the delay pulses P_d having different delay times are also generated through the second touch patterns y0 to y10 depending on the existence of a touch of the contact object or the touch position thereof, like the first touch patterns x0 to x5.

For example, the measurement part 120 may sequentially (simultaneously) apply a reference pulse P_r to one side of the first touch patterns x0 to x5 and the second touch patterns y0 to y10, and sequentially (or simultaneously) input delay pulses P_d generated from the other sides of the first touch patterns x0 to x5 and the second touch patterns y0 to y10 to calculate the measurement values P_V, outputting them. The measurement part 120 may be configured to apply a reference pulse P_r to one side of the first touch patterns x0 to x5 and the second touch patterns y0 to y10, and input delay pulses P_d generated from the one side of the first touch patterns x0 to x5 and the second touch patterns y0 to y10.

In addition, as shown in FIG. 3, the first touch patterns x0 to x5 may include a plurality of first touch pads PD1 disposed in a second direction (for example, a y-axial direction), and a plurality of first connection pads CP1 connecting the plurality of first touch pads PD1. In addition, the second touch patterns y0 to y10 may include a plurality of second touch pads PD2 disposed in a first direction (for example, an x- axial direction), and a plurality of second connection pads CP2 connecting the plurality of second touch pads PD2.

Further, while FIG. 3 illustrates the first touch pads PD1 and the second touch pads PD2 having a diamond shape, the first touch pads PD1 and the second touch pads PD2 may have a circular or polygonal shape. That is, the first touch pads PD1 and the second touch pads PD2 may be pads evenly formed at a certain region having a specific shape.

Next, when the touch pattern part 110 has the same shape as shown in FIG. 3, operations of the clustering part 220 and the center point calculating part 240 of the present invention will be described below.

As shown in FIG. 3, when the contact object is touched, the measurement values P_V (or standardized measurement values nP_V) generated through the first touch patterns x0 to x5, i.e., delay time of the delay pulses will be described as follows. Symbols dx0 to dx5 represent first measurement values (or standardized first measurement values) generated through the first touch patterns x0 to x5.

(dx0, dx1, dx2, dx3, dx4, dx5) =(0, 6, 137, 84, 9, 4)

In addition, the measurement values P_V (or standardized measurement values nP_V) generated through the second touch patterns y0 to y10, i.e., delay times of the delay pulses will be described as follows. Symbols dy0 to dy10 represent second measurement values (or standardized second measurement values) generated through the second touch patterns y0 to y10.

(dy0, dy1, dy2, dy3, dy4, dy5, dy6, dy7, dy8, dy9, dy10) =(1, 4, 45, 25, 2, 2, 13, 52, 58, 15, 4)

That is, the measurement part 120 (or the pre-processing part 210) outputs the first and second measurement values (or the standardized first and second measurement values) as the measurement values P_V (or the standardized measurement values nP_V.

The clustering part 220 receives the measurement values P_V (or the standardized measurement values nP_V) to operate the clustering operation by the following method.

Provided that each threshold in the first direction (for example, an x-axis) and the second direction (for example, a y-axis) is set to 20, the clustered measurement values nP_V will be represented as follows. Symbol nP_VCx represents clustered first measurement values generated using the first measurement value, and symbol nP_VCy represents clustered second measurement values generated using the second measurement values.

nP_VCx=(0, 0, 137, 84, 0, 0)

nP_VCy=(0, 0, 45, 25, 0, 0, 0, 52, 58, 0, 0)

It can be found from the clustered first measurement values nP_VCx that the number of a relative maximum value is one (that is, 137), and it can be determined that the number of cluster is one in the first direction, and it can be found from the clustered second measurement values nP_VCy that the number of a relative maximum values is two (that is, 45 and 58), and it can be determined that the number of cluster is two in the second direction. Thus it can be determined that the total number of cluster is two from the two-dimensional measurement values.

When the threshold value is set to a large value, the size of the cluster is reduced which limits accuracy of the coordinates of the center point, and when the threshold value is set to a small value, the size of the cluster is increased which makes the calculation of center point weak to noises. Therefore, the threshold value may be set by an experimental method or another suitable method. In addition, the threshold value may be set through a process of manufacturing the input device or by a user. For example, the threshold value may be set such that a distance between clusters is twice the size of an area touched by the contact object (for example, a finger).

As described above, the measurement values P_V (or the standardized measurement values nP_V) are clustered into a number of clusters determined by the clustering part 220.

Next, the center point calculating part 240 receives the clustered measurement values nP_VC and calculates coordinates of each cluster, i.e., a center point of the touch positions using a weighted average. That is, each clustered measurement value nP_VC is multiplied by the weighted value and the weighted measurement values are summed, and the summed value is divided by the summed clustered measurement values nP_VC to calculate coordinates of each cluster.

First, coordinates T_P(x) of the first direction (for example, the x-axis) and coordinates T_P(y) of the second direction (for example, the y-axis) of the cluster with respect to the touch position T_01 will be calculated as follows.

T_{—}P(x)=(137*2+84*3)/(137+84)=2.38

T_{—}P(y)=(45*2+25*3)/(45+25)=2.36

Therefore, the center point calculating part 240 outputs the coordinates of the cluster with respect to the touch position T_01, i.e., the coordinates (2.38, 2.36) of the calculated center point as the coordinates of the touch position T_01.

Next, coordinates T_P(x) of the first direction (for example, the x-axis) and coordinates T_P(y) of the second direction (for example, the y-axis) of the cluster with respect to the touch position T_02 will be calculated as follows.

T_{—}P(x)=(137*2+84*3)/(137+84)=2.38

T_{—}P(y)=(52*7+58*8)/(52+58)=7.53

Therefore, the center point calculating part 240 outputs the coordinates of the cluster with respect to the touch position T_02, i.e., the coordinates (2.38, 7.53) of the calculated center point as the coordinates of the touch position T_02.

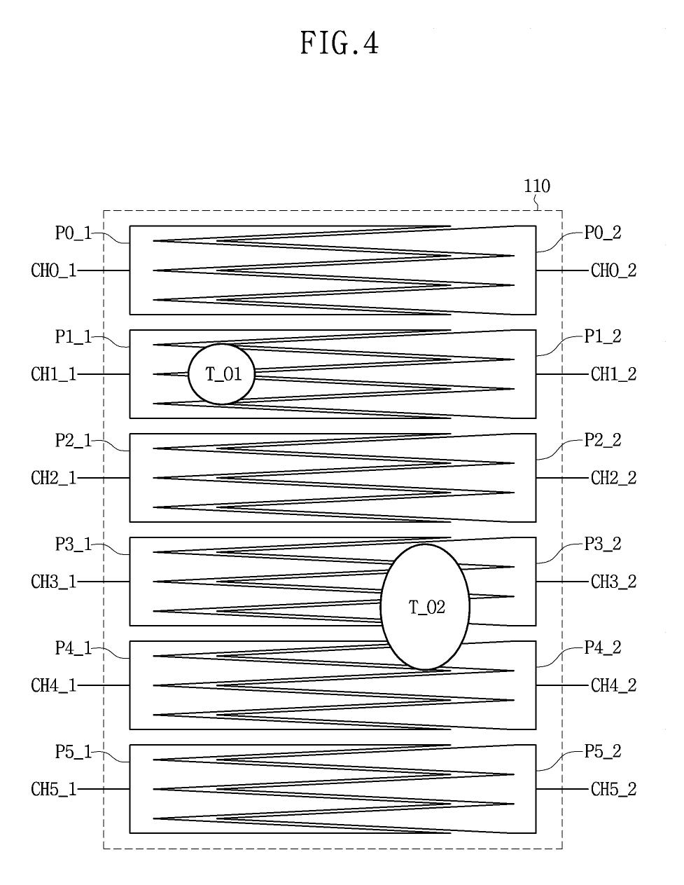

FIG. 4 shows a constitution of another embodiment of a touch pattern part 110 of the touch panel 100 of the input device shown in FIG. 2. The touch pattern part 110 may include a plurality of first touch patterns P0_1 to P5_1 disposed in a second direction (for example, a y-axis direction), and a plurality of second touch patterns P0_2 to P5_2 disposed in the second direction.

In addition, one side of the plurality of first touch patterns P0_1 to P5_1 in the first direction (for example, the x-axis direction) may be connected to the measurement part 120, and the other sides of the plurality of second touch patterns P0_2 to P5_2 in the first direction may be connected to the measurement part 120. Further, as shown in FIG. 4, the plurality of first touch patterns P0_1 to P5_1 may be formed to have a contact area that gradually reduces from the one side toward the other side in the first direction, and the plurality of second touch patterns P0_2 to P5_2 may be formed to have a contact area that gradually reduces from the other side toward the one side in the first direction. While FIG. 4 illustrates the first touch patterns P0_1 to P5_1 and of the plurality of second touch patterns P0_2 to P5_2 having a tooth shape, the first touch patterns P0_1 to P5_1 and of the plurality of second touch patterns P0_2 to P5_2 may have various shapes such as an equilateral triangle, a right triangle, etc.

When the touch pattern part 110 has the same shape as shown in FIG. 4, the measurement part 120 sequentially (or simultaneously) outputs a reference pulse P_r to first channels CH0_1 to CH5_1 at one side in the first direction of the plurality of first touch patterns P0_1 to P5_1 and second channels CH0_2 to CH5_2 at the other sides in the first direction of the plurality of second touch patterns P0_2 to P5_2, and sequentially (or simultaneously) receives delay pulses P_d generated from the first channels CH0_1 to CH5_1 and the second channels CH0_2 to CH5_2 to measure delay time differences between the reference pulses P_r and the delay pulses P_d, outputting measurement values P_V. As shown in FIG. 4, when the contact object is touched at two positions T_01, T_02), the measurement values P_V (or the standardized measurement values nP_V) will be measured as follows. Symbols d11 to d51 represent first measurement values corresponding to delay times of the delay pulses P_d generated from the first channels CH0_1 to CH5_1, and symbols d12 to d52 represent second measurement values corresponding to delay times of the delay pulses P_d generated from the second channels CH0_2 to CH5_2.

(d11, d21, d31, d41, d51) =(5, 35, 15, 51, 23, 4)=nP_Vx0

(d12, d22, d32, d42, d52) =(2, 22, 7, 56, 24, 3)=nP_Vx1

The measurement values become the first measurement values nP_Vx0 in the first direction and the second measurement values nP_Vx1 in the first direction.

In addition, the clustering part 220 calculates measurement values nP_Vy in the second direction using the measurement values. That is, the clustering part 220 adds the measurement values generated through touch patterns (P0_1, PO_2), (P0_1, PO_2), (P0_1, PO_2), (P0_1, PO_2), and (P0_1, PO_2) disposed at the same positions in the second direction to calculate the measurement values nP_Vy in the second direction. The measurement values nP_Vy in the second direction will be represented as follows.

nP_Vy=(7, 57, 22, 107, 47, 7)

When a threshold value in the second direction is set to 40, measurement values nP_VCy in the clustered second direction will be represented as follows.

nP_VCy=(0, 57, 0, 107, 47, 0)

Consequently first measurement values nP_VCx0 in the clustered first direction, second measurement values nP_VCx1 in the clustered first direction will be represented as follows.

nP_VCx0=(0, 35, 0, 51, 23, 0)

nP_VCx1=(0, 22, 0, 56, 24, 0)

The clustering operation should be done in the second direction only with nP_VCy. It can be found from the clustered measurement values that the number of relative maximum values is two (that is, 57 and 107), and thus, it can be determined that the number of cluster is two.

The center point calculating part 240 receives the first measurement values nP_VCx0 in the clustered first direction, the second measurement values nP_VCx1 in the clustered first direction, and the measurement values nP_VCy in the clustered second direction to calculate coordinates of each cluster of the touch positions T_01 and T0_2, i.e., coordinates of each center point of the touch positions T_01 and T_02. A method of calculating each center point of the touch positions using the center point calculating part 240 is similar to that of FIG. 3.

First, the coordinates in the first direction of the cluster with respect to the touch position T_01 will be calculated as follows.

(35*0+22*1)/(35 +22)=0.39

The coordinates in the second direction of the cluster with respect to the touch position T_01 will be calculated as follows.

(57*1)/57=1

Therefore, the center point calculating part 240 outputs the coordinates of the cluster with respect to the touch position T_01, i.e., coordinates (0.39, 1) of the calculated center point as the coordinates of the touch position T_01.

Next, the coordinates in the first direction of the cluster with respect to the touch position T_02 will be calculated as follows.

((51+23)*0+(56+24)*1)/((51+23)+(56+24))=0.52

The coordinates in the second direction of the cluster with respect to the touch position T_02 will be calculated as follows.

(107*3+47*4)/(107+47)=3.31

Therefore, the center point calculating part 240 outputs the coordinates of the cluster with respect to the touch position T_02, i.e., coordinates (0.52, 3.31) of the calculated center point as the coordinates of the touch position T_02.

While the embodiment illustrates that the coordinates in the second direction (for example, the y-axis direction) are calculated through the clustering operation, when the touch pattern part 110 has the same constitution as shown in FIG. 4, the coordinates in the second direction may be calculated by determining whether the contact object touches a certain touch pattern. Therefore, when the touch pattern part 110 has the same constitution as shown in FIG. 4, only the coordinates in the first direction (for example, the x-axis direction) may be calculated through the clustering operation. For example, in the case of the touch position T_01 that the contact object touches only the touch patterns P1_1 and P1_2 which are disposed in the same row, only the coordinates in the x-axis direction may be calculated through the clustering operation.

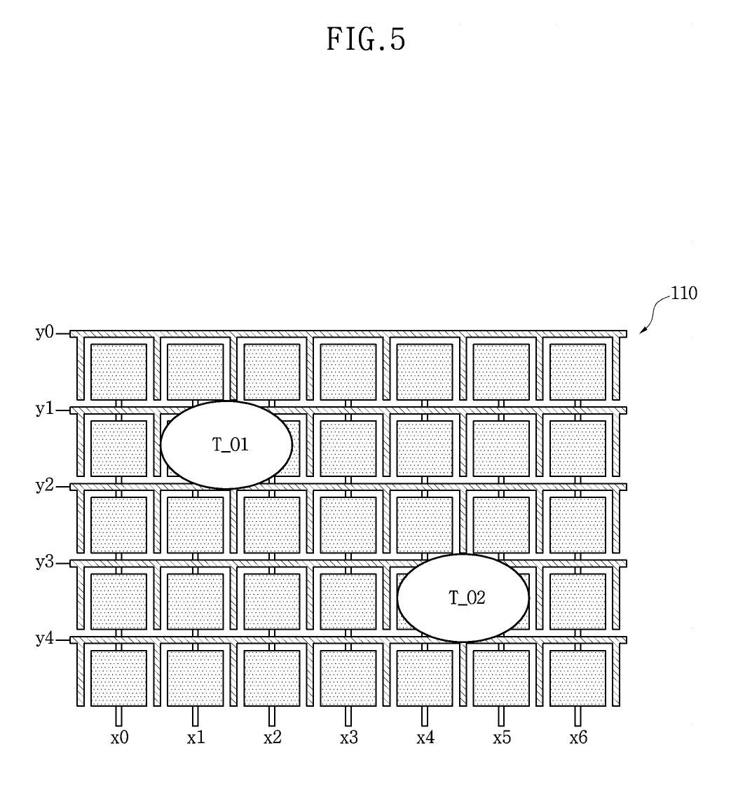

FIG. 5 shows a constitution of still another embodiment of a touch pattern part 110 of the touch panel 100 of the input device shown in FIG. 2. The touch pattern part 110 may include a plurality of first touch patterns x0 to x6 disposed in a first direction, and a plurality of second touch patterns y0 to y4 disposed in a second direction.

As shown in FIG. 5, the first touch patterns x0 to x6 may include a plurality of touch pads disposed in a second direction (for example, a y-axis direction), and a plurality of connection pads connecting the plurality of touch pads. In addition, the second touch patterns y0 to y4 may include a plurality of bars extending in a first direction (for example, an x-axis direction), and a plurality of bars connected to the bars extending in the first direction, extending in the second direction, and disposed at sides in the first direction of the plurality of touch pads of the first touch patterns x0 to x6.

In addition, similar to FIG. 3, the first touch patterns x0 to x6 may be insulated from the second touch patterns y0 to y4.

When the touch pattern 110 is formed as shown in FIG. 5, the measurement part 120 sequentially applies signals to the second touch patterns y0 to y4, and receives signals output from the first touch patterns x0 to x6 to measure capacitance between the touch patterns. The magnitude of the capacitance between the touch patterns, to which the contact object is touched, is reduced by blocking a fringe field using the contact object. Therefore, when the touch pattern part 110 is formed as shown in FIG. 5, the measurement part 120 can measure an input signal, i.e., a coupled signal, to calculate capacitance of the touch patterns. A circuit for measuring the coupled signal to calculate the capacitance may be variously constituted. Since specific circuits are already known, detailed description thereof will be omitted.

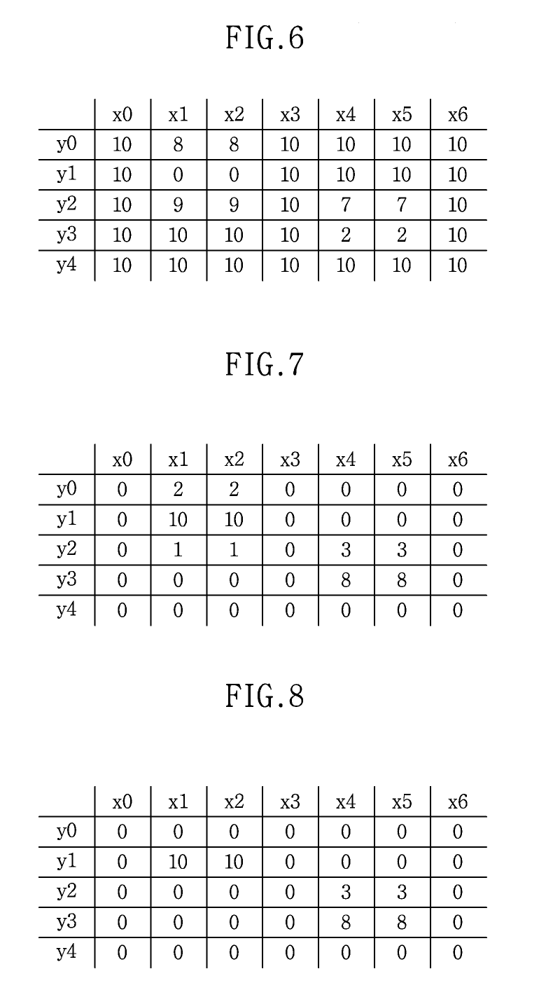

FIG. 6 shows measurement values P_V (or standardized measurement values nP_V) when the touch pattern part 110 is formed as shown in FIG. 5, and the contact object is in contact with two positions T_01 and T_02 as shown in FIG. 5. Hereinafter, for the convenience of description, it will be described using the measurement values P_V (or the standardized measurement values nP_V) instead of the magnitude of the measured capacitance.

FIGS. 7 and 8 are views for explaining an operation of a clustering part 220 when the touch pattern part 110 has the same constitution as shown in FIG. 5. When the touch pattern part 110 has the same shape as shown in FIG. 5, the clustering part 220 subtracts each measurement value shown in FIG. 6 from a predetermined reference value, and then, outputs clustered measurement values nP_VC including at least one cluster constituted by a value larger than a predetermined threshold value, among the subtracted measurement values. Here, the predetermined reference value may be the same value as the measurement value when the touch pattern part 110 is not touched by the contact object.

FIG. 7 shows values where the measurement values P_V (or the standardized measurement values nP_V) shown in FIG. 6 is subtracted from a reference value (for example, 10).

FIG. 8 shows results of performing the clustering using the measurement values P_V (or the standardized measurement value nP_V) shown in FIG. 7, when each of the threshold values in the first and second directions is 2.

The center point calculating part 240 calculates coordinates of each cluster corresponding to the touch positions T_01 and T_02, i.e., coordinates of each center point of the touch positions T_01 and T_02 using the clustered measurement values nP_VC shown in FIG. 8. A method of calculating coordinates of each cluster is similar to the description in FIG. 3. That is, in each cluster, the center point calculating part 240 calculates coordinates in the first direction using a weighted average of the measurement values in the first direction among the clustered measurement values nP_VC constituting each cluster, calculates coordinates in the second direction using a weighted average of the measurement values in the second direction among the clustered measurement values nP_VC constituting each cluster, and combine the coordinates in the first direction and the second direction to calculate coordinates of each cluster and output the coordinates.

That is, the coordinates in the first direction of the cluster with respect to the touch position T_01 is calculated as follows.

(10*1+10*2)/(10+10)=1.5

The coordinates in the second direction of the cluster with respect to the touch position T_01 is calculated as follows.

(10*1)/10=1

Therefore, the center point calculating part 240 outputs (1.5, 1) as the coordinates of the cluster with respect to the touch position T_01 as the coordinates of the touch position T_01.

Next, the coordinates in the first direction of the cluster with respect to the touch position T_02 is calculated as follows.

((3+8)*4+(3+8)*5)/((3+8)+(3+8))=4.5

The coordinates in the second direction of the cluster with respect to the touch position T_2 is calculated as follows.

((3+3)*2+(8+8)*3)/((3+3)+(8+8))=2.64

Therefore, the center point calculating part 240 outputs (4.5, 2.64) as the coordinates of the cluster with respect to the touch position T_02 as the coordinates of the touch position T_02.

The touch pattern part 110 may be used by variously altering the embodiments shown in FIGS. 3, 4 and 5. For example, in the case of the touch pattern part 110 shown in FIG. 3, the first and second touch pads PD1 and PD2 disposed at both ends of the first and second touch patterns x0 to x5 and y0 to y10 may have a triangular shape, which has been cut into half from a diamond shape, or have other shapes, each of which has been cut into half from another shape. In addition, the first and second touch pads PD1 and PD2 may have different areas or shapes. Further, in the case of the touch pattern part 110 shown in FIG. 4, the first touch patterns P0_1 to P5_1 and the second touch patterns P0_2 to P5_2 may be connected to each other at their both ends.

As described above, when the touch pattern part 110 is used in an altered state, when a process of making a transparent window (or lens) convex on the touch pads is added so that gaps between surfaces of the touch pads become irregular or when gaps between the touch pad and the surface of the display device under the touch pad are not uniform due to assembly distribution in manufacturing processes, or the like, in other words, when it is difficult to accurately calculate a center point of the touch positions using the measurement values P_V (or the standardized measurement values nP_V), the center point of the touch positions may be calculated by adding or subtracting an offset value to/from the measurement values P_V (or the standardized measurement values nP_V) or using the measurement values P_V (or the standardized measurement values nP_V) multiplied by a separated weight value. Notice that the adding or subtracting is as like as an adaptive change of the threshold value, but the multiplication by the separated weight value play another function to correct non-linearity such as thickness difference caused by the convex transparent window and resistance difference caused by distance between sensing terminal and touch location.

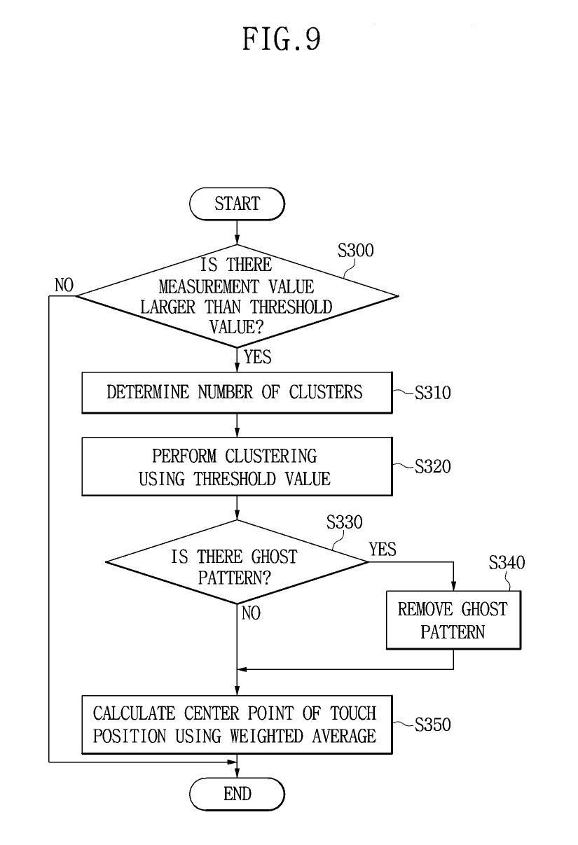

FIG. 9 is a flowchart for explaining a touch position detecting method of an input device in accordance with the present invention.

Hereinafter, the touch position detecting method of an input device in accordance with the present invention will be described with reference to FIG. 9.

First, it is determined whether there is a measurement value P_V (or a standardized measurement value nP_V) larger than a threshold value (S300). If it is determined that there is no measurement value larger than the threshold value, the method is completed.

Next, the number of clusters is determined using the measurement values P_V (or the standardized measurement values nP_V) (S310). For example, relative maximum values may be detected from the measurement values P_V (or the standardized measurement values nP_V), and the number of relative maximum values may be determined as the number of clusters.

Next, clustering is performed using the threshold value (S320). As described above, the clustering may be performed by a method of substituting a measurement value smaller than the threshold value with ‘0’. As a result of the clustering, the clustered measurement values nP_VC have at least one cluster.

Next, it is determined whether a ghost pattern exists (S330). For example, in the case that the touch pattern part 110 has the same constitution as shown in FIG. 3, it is possible to determine that the ghost pattern exists when at least two touch positions in the first direction exist in the measurement values generated from the first touch patterns x0 to x5 and at least two touch positions in the second direction exist in the measurement values generated from the second touch patterns y0 to y10.

When the ghost pattern exists as a result of the determination in S330, the ghost pattern is removed and an actual touch position is determined (S340). For example, in the case that the touch pattern part 110 has the same constitution as shown in FIG. 3, it is possible to remove the ghost pattern and determine the actual touch position by comparing the measurement values of at least two touch positions generated from the first touch patterns x0 to x5 and comparing the measurement values of at least two touch positions generated from the second touch patterns y0 to y10.

Next, the clustered measurement values nP_VC are input to calculate coordinates of each cluster using a weighted average (S350). That is, with respect to each cluster (i.e., each touch position), coordinates of each cluster which are calculated using the weighted average, are calculated and output as the coordinates of the touch position.

While the embodiments illustrate the case wherein a center point of the contacted part (for example, a center point using a weighted average) is calculated and the center point is output as the coordinates of the touch position, coordinates in consideration of the offset according to the contact object at the calculated center point may be output as the coordinates of the touch position. For example, when the contact object is recognized as a finger, a contour line according to touch values of the finger (for example, the measurement values P_V (or the standardized measurement values nP_V)) may be obtained to obtain the size of a template of the finger, and the coordinates added by the offset corresponding to the coordinates of the calculated center point may be output as the coordinates of the touch position.

The forgoing description concerns an exemplary embodiment of the invention, is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

1. An input device comprising:
a touch panel configured to generate a plurality of different measurement values depending on touch positions and output the plurality of measurement values;
a clustering part configured to receive the measurement values, and output clustered measurement values including at least one cluster from the plurality of measurement values using a threshold value; and
a center point calculating part configured to receive the clustered measurement values, and calculate coordinates of each cluster using a weighted average to output the coordinates.

2. The input device according to claim 1, wherein the cluster is constituted by the measurement values larger than the threshold value, among the measurement values.

3. The input device according to claim 1, wherein the clustering part receives the measurement values to detect the number of relative maximum values of the measurement values, and outputs the clustered measurement values including the same number of clusters as the number of the relative maximum values from the measurement values.

4. The input device according to claim 1, wherein the touch panel comprises:
a touch pattern part including a plurality of touch patterns; and
a measurement part configured to output an input signal to at least one touch pattern among the plurality of touch patterns, and receive an output signal generated through at least one touch pattern among the plurality of touch patterns to calculate the plurality of measurement values.

5. The input device according to claim 4, wherein the touch pattern part comprises:
a plurality of first touch patterns disposed in a first direction; and
a plurality of second touch patterns disposed in a second direction perpendicular to the first direction.

6. The input device according to claim 5, wherein each of the plurality of first touch patterns comprises:
a plurality of first touch pads disposed in the second direction; and
a plurality of first connecting pads configured to connect the plurality of first touch pads.

7. The input device according to claim 6, wherein each of the plurality of second touch patterns comprises:
a plurality of second touch pads disposed in the first direction; and
a plurality of second connecting pads configured to connect the plurality of second touch pads.

8. The input device according to claim 7, wherein the measurement part applies a first reference pulse to each of the first touch patterns as the input signal, receives a first delay pulses generated through the first touch patterns as the output signal, and measures delay time differences between the first delay pulses and the first reference pulse to calculate first measurement values; and applies a second reference pulse to each of the second touch patterns as the input signal, receives a second delay pulses generated through the second touch patterns as the output signals, measures delay time differences between the second delay pulses and the second reference pulse to calculate second measurement values, and outputs the first measurement values and the second measurement values as the measurement value.

9. The input device according to claim 8, wherein the clustering part outputs clustered first measurement values including at least one first cluster having a value larger than a first threshold value among the first measurement values and clustered second measurement values including at least one second cluster having a value larger than a second threshold value among the second measurement values as the clustered measurement value.

10. The input device according to claim 9, wherein the center point calculating part calculates coordinates in the first direction using a weighted average with respect to each of the first clusters, calculates coordinates in the second direction using a weighted average with respect to each of the second clusters, and combines the coordinates in the first and second directions to calculate and output coordinates of each cluster.

11. The input device according to claim 4, wherein the touch pattern part comprises:
a plurality of first touch patterns extending in a first direction, connected to the measurement part at one side in the first direction, and disposed in a second direction; and
a plurality of second touch patterns extending in the first direction, connected to the measurement part at the other side in the first direction, and disposed in the second direction,
wherein each of the first touch patterns has a contact area that decreases toward the other side in the first direction; and each of the second touch patterns has a contact area that decreases toward the one side in the first direction.

12. The input device according to claim 11, wherein the measurement part applies a first reference pulse to the one side in the first direction with respect to the first touch patterns as the input signal, receives a first delay pulse generated from the one side in the first direction as the output signal, and measures a delay time difference between the first reference pulse and the second delay pulse to calculate a first measurement value; and applies a second reference pulse to the other side in the first direction with respect to the second touch patterns as the input signal, receives a second delay pulse generated from the other side in the first direction as the output signal, measures a delay time difference between the second reference pulse and the second delay pulse to calculate a second measurement value, and outputs the first measurement values and the second measurement values as the measurement value.

13. The input device according to claim 12, wherein the clustering part receives the first measurement values to calculate clustered first measurement values in the first direction using a first threshold value, receives the second measurement values to calculate clustered second measurement values in the first direction using the first threshold value, calculates measurement values in a second direction added by the first and second measurement values with respect to the first and second touch patterns disposed at corresponding positions in the second direction among the first and second measurement values, receives the measurement values in the second direction to calculate clustered measurement values in the second direction using a second threshold value, and outputs the clustered first measurement values in the first direction, the clustered second measurement values in the first direction, and the clustered measurement values in the second direction as the clustered measurement value.

14. The input device according to claim 13, wherein the center point calculating part calculates coordinates in the first direction of the cluster using a weighted average of corresponding values among the clustered first measurement values in the first direction and the clustered second measurement values in the first direction, and calculates coordinates in the second direction of the cluster using a weighted average of the clustered measurement values in the second direction.

15. The input device according to claim 6, wherein each of the plurality of second touch patterns comprises:
a first bar extending in the first direction; and
a plurality of second bars connected to the first bar, extending in the second direction, and disposed at sides in the first direction of the first touch pads.

16. The input device according to claim 15, wherein the measurement part applies the input signal to each of the second touch patterns, receives the output signal generated from the first touch patterns to measure capacitances between the first touch patterns and the second touch patterns, and outputs the measured capacitance as the measurement values.

17. The input device according to claim 16, wherein the clustering part subtracts the measurement values from a reference value, and then outputs the clustered measurement value including at least one cluster having a larger value than the threshold value among the subtracted resultant values.

18. The input device according to claim 17, wherein the center point calculating part calculates coordinates in the first direction using a weighted average of the measurement values in the first direction among the clustered measurement values with respect to each of the clusters, calculates coordinates in the second direction using a weighted average of the measurement values in the second direction among the clustered measurement values, and combines the coordinates in the first and second directions to calculate and output coordinates of each cluster.

19. The input device according to claim 1, further comprising a pre-processing part configured to receive the measurement values, remove noises, and output standardized measurement values,
wherein the clustering part receives the standardized measurement values to output the clustered measurement values.

20. The input device according to claim 1, further comprising a pre-processing part configured to receive the measurement values, perform a correction operation, and output standardized measurement values, and
wherein the clustering part receives the standardized measurement values to output the clustered measurement values.

21. A touch position detecting method of an input device including a touch panel configured to generate a plurality of measurement values having different value depending on a touch position and output the plurality of measurement values, the method comprising:
a clustering step of receiving the measurement values, and outputting a clustered measurement values including at least one cluster from the plurality of measurement values using a threshold value; and
a center point calculating step of receiving the clustered measurement values, and calculating and outputting coordinates of each cluster using a weighted average.

22. The method according to claim 21, wherein the cluster is constituted by the measurement values larger than the threshold value among the measurement values.

23. The method according to claim 21, wherein the clustering step comprises:
receiving the measurement values to detect the number of relative maximum values of the measurement values, and
outputting the clustered measurement values including the same number of clusters as the number of the relative maximum values from the measurement values.

24. The method according to claim 21, wherein the touch panel comprises a plurality of first touch patterns disposed in a first direction, and a plurality of second touch patterns disposed in a second direction perpendicular to the first direction, wherein each of the plurality of first touch patterns comprises a plurality of first touch pads disposed in the second direction, and a plurality of first connecting pads configured to connect the plurality of first touch pads; and each of the plurality of second touch patterns comprises a plurality of second touch pads disposed in the first direction; and a plurality of second connecting pads configured to connect the plurality of second touch pads; and
the touch position detecting method further comprises a measurement step of applying a reference pulse to each of the first touch patterns, measuring a delay time difference between a delay pulse generated through the first touch patterns and the reference pulse to calculate first measurement values, applying the reference pulse to the second touch patterns, measuring a delay time difference between a delay pulse generated through the second touch patterns and the reference pulse to calculate second measurement values, and outputting the first measurement values and the second measurement values as the measurement value.

25. The method according to claim 24, wherein the clustering step comprises outputting clustered first measurement values including at least one first cluster having a value larger than the first threshold value among the first measurement values and clustered second measurement values including at least one second cluster having a value larger than the second threshold value among the second measurement values as the clustered measurement value.

26. The method according to claim 25, wherein the center point calculating step comprises calculating coordinates in the first direction using a weighted average with respect to each of the first clusters, calculating coordinates in the second direction using a weighted average with respect to each of the second clusters, and combining the coordinates in the first and second directions to output coordinates of each cluster.

27. The method according to claim 21, wherein the touch panel comprises a plurality of first touch patterns extending in a first direction and disposed in a second direction; and a plurality of second touch patterns extending in the first direction and disposed in the second direction, wherein each of the first touch patterns has a contact area that decreases toward one side in the first direction, and each of the second touch patterns has a contact area that decreases toward the other side in the first direction, and
the touch position detecting method further comprises a measurement step of applying a reference pulse to the one side in the first direction with respect to each of the first touch patterns, measuring a delay time difference between the reference pulse and a delay pulse generated from the one side in the first direction to calculate a first measurement value, applying a reference pulse to the other side in the first direction with respect to each of the second touch patterns, measuring a delay time difference between the reference pulse and a delay pulse generated from the other side in the first direction to calculate a second measurement value, and outputting the first measurement values and the second measurement values as the measurement value.

28. The method according to claim 27, wherein the clustering step comprises receiving the first measurement values to calculate clustered first measurement values in a first direction using a first threshold value, receiving the second measurement values to calculate clustered second measurement values in the first direction using the first threshold value, calculating measurement values in a second direction added by the first measurement value and the second measurement value with respect to the first touch pattern and the second touch pattern disposed at corresponding positions in the second direction among the first measurement values and the second measurement values, receiving the measurement value in the second direction to calculate clustered measurement values in the second direction using a second threshold value, and outputting the clustered first measurement values in the first direction, the clustered second measurement values in the first direction, and the clustered measurement values in the second direction as the clustered measurement value.

29. The method according to claim 28, wherein the center point calculating step comprises calculating coordinates in the first direction of the cluster using a weighted average of corresponding values among the clustered first measurement values in the first direction and the clustered second measurement values in the first direction, and calculating coordinates in the second direction of the cluster using a weighted average of the clustered measurement values in the second direction.

30. The method according to claim 21, wherein the touch panel comprises a plurality of first touch patterns disposed in a first direction, and a plurality of second touch patterns disposed in a second direction perpendicular to the first direction, wherein each of the plurality of first touch patterns comprises a plurality of first touch pads disposed in the second direction, and a plurality of first connecting pads connecting the plurality of first touch pads, and each of the plurality of second touch patterns comprises a first bar extending in the first direction, and a plurality of second bars connected to the first bar, extending in the second direction, and disposed at sides in the first direction of each of the first touch pads, and
the touch position detecting method comprises applying the input signal to each of the second touch patterns, receiving the output signal generated from the first touch patterns to measure capacitances between the first touch patterns and the second touch patterns, and outputting the measured capacitances as the measurement values.

31. The method according to claim 30, wherein the clustering step comprises subtracting the measurement values from a reference value, and then, outputting the clustered measurement value including at least one cluster constituted by values larger than the threshold value among the subtracted resultant values.

32. The method according to claim 31, wherein the center point calculating step comprises, with respect to the clusters, calculating coordinates in the first direction using a weighted average of the measurement values in the first direction among the clustered measurement values, calculating coordinates in the second direction using a weighted average of the measurement values in the second direction among the clustered measurement values, and combining the coordinates in the first and second directions to calculate and output coordinates of each cluster.
